(19) United States
(12) Patent Application Publication
(10) Pub. No.: US 2013/0029500 A1
(43) Pub. Date: Jan. 31, 2013

(54) CONNECTOR AND FABRICATION METHOD THEREOF

(71) Applicants: Chih-Peng Fan, Taoyuan County (TW); Ling-Kai Su, Taipei City (TW); Yen-Ti Chia, New Taipei City (TW)

(72) Inventors: Chih-Peng Fan, Taoyuan County (TW); Ling-Kai Su, Taipei City (TW); Yen-Ti Chia, New Taipei City (TW)

(21) Appl. No.: 13/450,485

(22) Filed: Apr. 19, 2012

(30) Foreign Application Priority Data
Jul. 25, 2011 (TW) 100126202
Nov. 9, 2011 (TW) 100140879

(51) Int. Cl. H01R 12/71; H01R 43/16

(52) U.S. Cl. 439/66; 29/885

(57) ABSTRACT

The present invention provides a connector including a substrate, at least a conductive via disposed inside the substrate, a pad disposed on one surface of the substrate and electrically connected to the conductive via, a resilient flange disposed on the pad, and an anisotropic conductive adhesive interposed between the pad and the resilient flange to electrically connect the pad with the resilient flange.

### BACKGROUND OF THE INVENTION

1. Field of the Invention

The present invention generally relates to connectors, and more particularly, to a connector having an anisotropic conductive adhesive. The invention is further completed with a method of fabricating the inventive connector.

2. Description of the Prior Art

As the input/output (I/O) pin count and the circuit density of the integrated circuit (IC) chips continue to increase, the process of bonding or mounting a chip module onto a printed circuit board (PCB) becomes a big challenge. In current approaches, as shown in FIG. 1A, the chip module 1 is usually directly mounted on the PCB 3 by a soldering method such as in a ball grid array (BGA). However, the soldering process of such connections is not reversible and the cost is high when replacement of the chip module is required after assembly.

To cope with the problem, manufacturers and researchers are therefore developing a technology, wherein an interposer is provided and interposed between a chip module and a PCB. As shown in FIG. 1B, an interposer 50 is provided and disposed between a carrier substrate (not shown) and a PCB (not shown), wherein the interposer 50 includes a substrate 12, a plurality of flexible contact members 20 mounted on a chip mounting side or a chip side of the substrate 12. Each flexible contact member 20 is electrically connected to a plated through hole 11 by a conductive metal layer conformally formed on the surface of the flexible contact member 20. The common steps for producing the interposer 50 include a step of fabricating the flexible contact member 20 and the substrate 12 separately and a step of imposing the flexible contact member 20 on an adhesive layer 15, such as a low-flow prepreg, located on the substrate.

The above-described prior art, however, has several drawbacks. In general, the conventional fabrication processes for the connectors 50 include complicated and expensive steps, such as providing an adhesive layer 15 to have a copper foil, having several flexible contact members 20 fixed on the substrate 12 and treating the flexible contact members 20 with electroless plating and electroplating processes sequentially, like copper, nickel, gold electroplating and so forth, in order to form at least a layer of thin conductive metal layer 16. The purpose of the conductive metal layer 16 is to improve the conductance and modify the surface properties of the resilient flanges 20. By providing the thin conductive metal layer 16, each of the resilient flanges 20 can be electrically connected to the plated through hole 11 inside the substrate 12. However, since the conductive metal layer 16 near the plated through hole 11 and the resilient flanges 20 is fragile, once it is broken, the signal transmission between the plated through hole 11 and the resilient flange 20 is affected and the reliability of the connector 50 is therefore reduced.

### SUMMARY OF THE INVENTION

It is therefore one objective of the invention to provide an improved connector and a fabrication method thereof to overcome the above-described prior art problems.

To address these and other objects, according to one embodiment, the present invention provides a connector including the following components: a substrate; at least a conductive via disposed inside the substrate; a pad disposed on one surface of the substrate and electrically connected to the conductive via; a resilient flange disposed on the pad; and an anisotropic conductive adhesive interposed between the pad and the resilient flange to electrically connect the pad to the resilient flange.

According to another preferred embodiment of the invention, a connector includes the following components: a substrate comprising a core dielectric, a first circuit layer, a second circuit layer and at least one conductive via, wherein the dielectric core has a first surface and a second surface opposite to the first surface, the first circuit layer and the second circuit layer are located on the first surface and the second surface respectively, and the conductive via is located in the core dielectric and connected to the first circuit layer and the second circuit layer; at least a resilient flange disposed on the first circuit layer, wherein the resilient flange comprise a fixed end and a free distal end connected to the fixed end, and an upper surface of the free distal end is higher than an upper surface of the fixed end; and an adhesive layer interposed between the first circuit layer and the resilient flange, wherein the adhesive layer has at least one through hole plugged into a conductive material and the conductive material is electrically in contact with the first circuit layer and the fixed end.

According to still another embodiment of the invention, a method for fabrication a connector is provided which comprises the following processes. First, a substrate having at least a conductive via is provided. Then, at least a pad is formed on a surface of the substrate, wherein the pad is electrically in contact with the conductive via. Finally, both an anisotropic conductive adhesive and a resilient flange are combined with the surface of the substrate so that the resilient flange is electrically in contact with the pad through the anisotropic conductive adhesive.

According to yet another embodiment, the present invention provides a method for fabricating a connector. The method includes processes as follows.

First, a substrate is provided which includes a core dielectric, a first circuit layer, a conductive layer and at least one conductive via, wherein the core dielectric has a first surface and a second surface opposite to the first surface, the first circuit layer and the conductive layer are located on the first surface and the second surface respectively, and the conductive via is located in the core dielectric and connected to the first circuit and the conductive layer. Then, an adhesive layer is provided which includes at least one through hole plugged with a conductive material. A patterned metal foil having at least a resilient flange pattern, wherein the resilient flange comprises a fixed end and a free distal end connected with the fixed end is provided. Then, the adhesive layer and the patterned metal foil are combined with the substrate, wherein the adhesive material is interposed between the substrate and the patterned metal foil, and the conductive material is electrically in contact with the first circuit layer and the fixed end. Finally, a portion of the patterned metal foil is removed so that the fixed end and the free distal end remain, wherein the fixed end and the free distal end consist of a resilient flange, followed by patterning the conductive layer to form a second circuit layer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the embodiments, and are incorporated in and constitute a part of this specification. The drawings illustrate some of the embodiments and, together with the description, serve to explain their principles.

FIG. 1A is a schematic diagram showing a conventional structure of a chip module soldered to a PCB.

FIG. 1B is a schematic diagram showing a structure of a conventional connector.

FIGS. 2 to 5 are schematic diagrams showing a method for fabricating connectors according to embodiments of the present invention, wherein:

FIG. 2A is schematic, cross-sectional diagram of a substrate;

FIG. 2B to FIG. 2C are schematic diagrams illustrating a fabrication method for a copper foil according to one embodiment of the invention;

FIG. 2D are schematic diagram showing a connector after imposing the copper foil shown in FIG. 2C to an anisotropic conductive adhesive and a substrate simultaneously followed by performing a circuit fabrication process;

FIG. 2E is a schematic, three-dimensional diagram of the connector shown in FIG. 2D;

FIG. 2F is a schematic, partially enlarged diagram of the connector encircled in FIG. 2D;

FIG. 3 is schematic diagram showing a connector according to one embodiment of the invention;

FIGS. 4A to 4C are schematic, cross-sectional diagrams showing a method for fabricating an adhesive layer used in a connector according to one embodiment of the invention;

FIG. 4D to FIG. 4E are a schematic diagrams showing a method for fabricating connectors according to one embodiment of the present invention; and

FIG. 5 is a schematic, cross-sectional diagram showing an interposer interposed between a chip module and a PCB according to one embodiment of the invention.

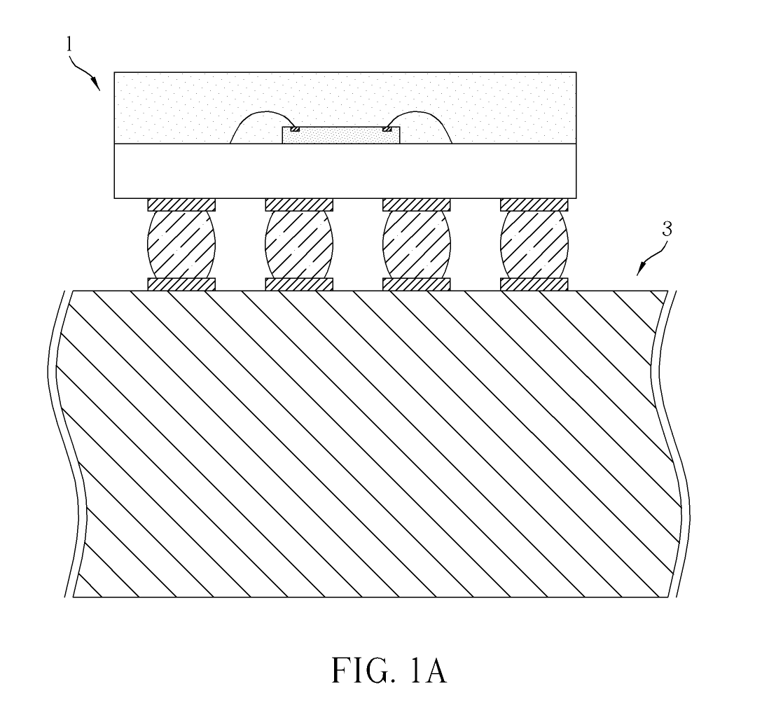

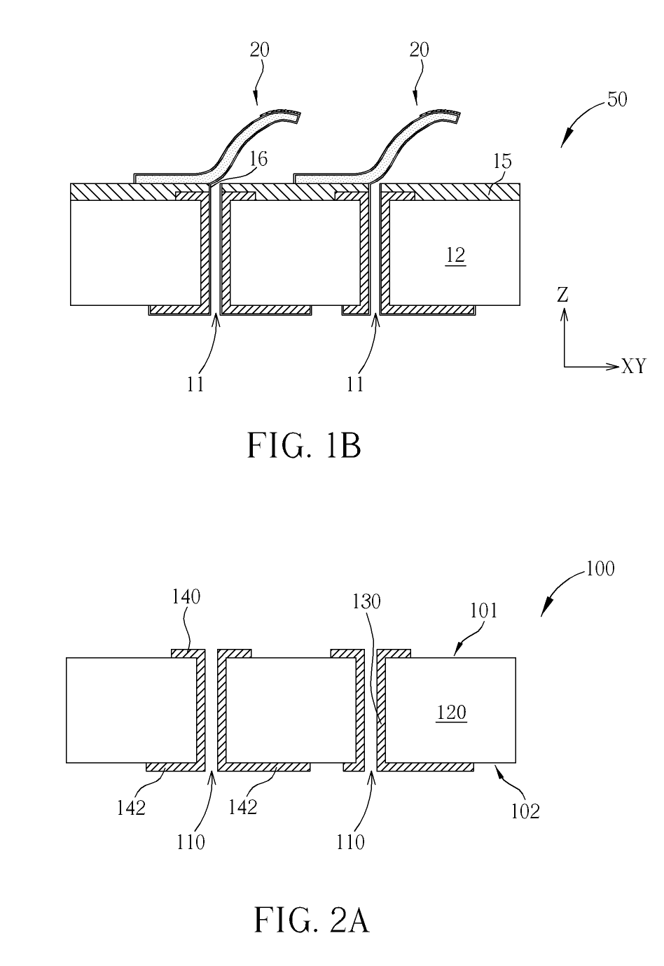

It should be noted that all the figures are diagrammatic. Relative dimensions and proportions of parts of the drawings have been shown exaggerated or reduced in size for the sake of clarity and convenience in the drawings. The same reference signs are generally used to refer to corresponding or similar features in modified and different embodiments.

### DETAILED DESCRIPTION

In the following description, numerous specific details are given to provide a thorough understanding of a fabricating method related to the invention. It will, however, be apparent to one skilled in the art that the invention may be practiced without these specific details. Furthermore, some well-known system configurations and process steps are not disclosed in detail, as these should be well-known to those skilled in the art.

Likewise, the drawings showing the embodiments of the apparatus are not to scale and some dimensions are exaggerated for clarity of presentation. Also, when multiple embodiments are disclosed and described as having some features in common, like or similar features will usually be described with same reference numerals for ease of illustration and description thereof.

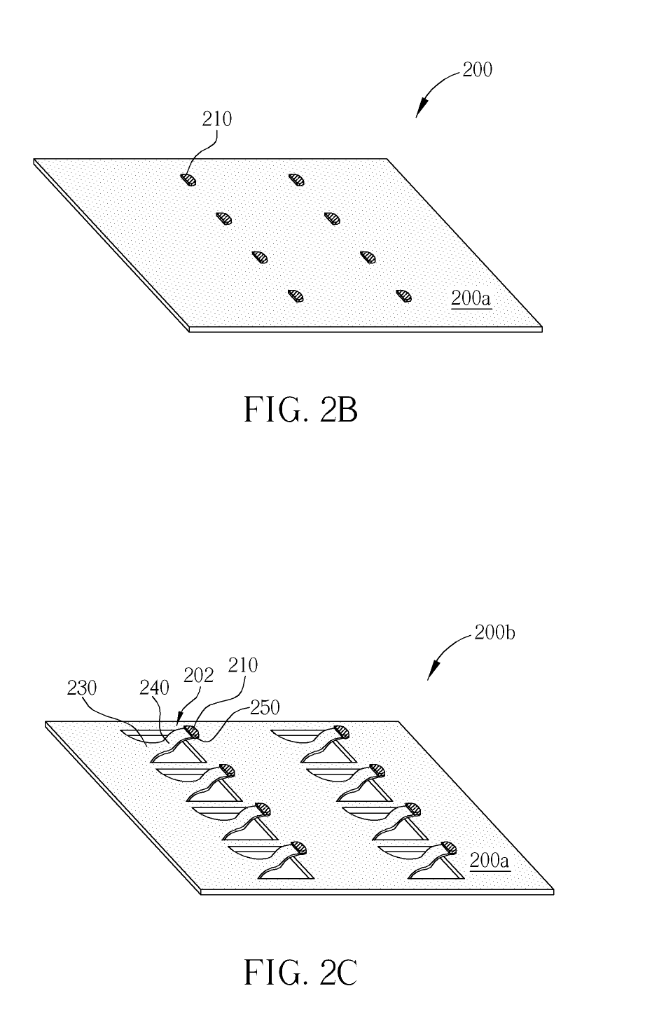

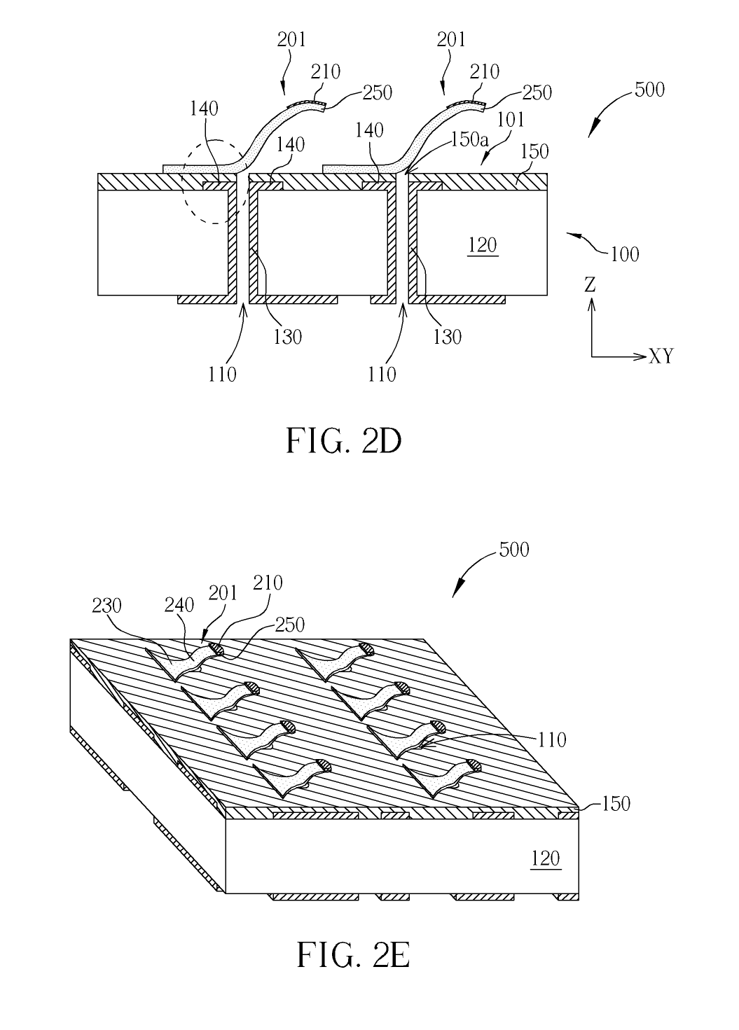

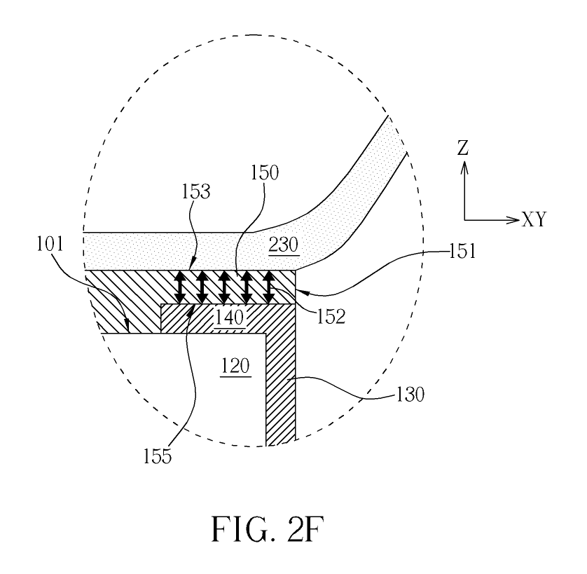

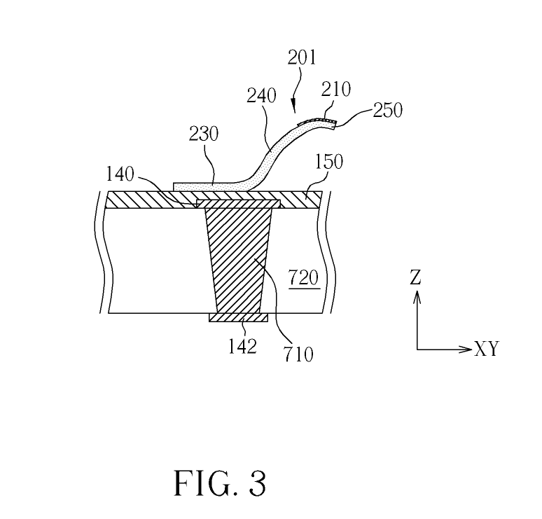

FIGS. 2A to 3 are schematic diagrams illustrating a method for fabricating a connector according to first exemplary embodiment of the present invention. As shown in FIG. 2A, a substrate 100 is provided which may be chosen from various kind of PCBs, such as a single-layered PCB or multi-layered PCB. In this embodiment, the substrate 100 is a double-layered PCB including a core dielectric 120 and two conductive layers (not shown), like copper foil, on its surfaces. Then, a plurality of conductive through vias is formed inside the core dielectric 120, such as plated through vias or through vias plugged with conductive paste. The conductive through vias are preferably chosen from the plated through vias 110 and are formed through drilling and plating processes. In this embodiment, the plated through vias 110 can penetrate through both sides of the core dielectric 120. In order to obtain various circuits on the surface of the core dielectric 120, a circuit patterning process is performed to thereby form desired circuits on a first surface 101 and a second surface 102 of the core dielectric 120. In addition, during the patterning process, several pads 140 and 142 are also formed on the surface 101 and 102 of the core dielectric 120. It is worth noting that each of the pads 140 is electrically connected to the corresponding pads 142 through the conductive layer 130 located on the sidewalls of the plated through vias 110. Additionally, according to this embodiment, the pads 140 are arranged in an array.

Please refer to FIGS. 2B to 2C. FIGS. 2B and 2C are schematic diagrams illustrating a fabrication method for a copper foil according to one embodiment of the invention. As shown in FIG. 2B, a metal foil 200, such as a copper foil alloyed with beryllium element or other composite foils with copper elements, is provided. Since a copper foil alloyed with beryllium has a relatively high mechanical strength and an elastic factor, it may be one of the preferred choices for the metal foil 200 in this embodiment. In this case, the plastic deformation of the metal foil 200 is hard to occur during shaping processes. Optionally, at least a layer of nickel is plated on at least one surface 200a of the metal foil 200 followed by performing an optional plating process of gold. In the process of gold plating, photoresist (not shown) may be deposited to cover all non-plated regions so that gold parts 210 are only plated on a certain region. The nickel plated on the metal foil 200 may not only strengthen the adhesion capacity of the gold parts 210 to the metal foil 200 and prevent metal foil 200 from oxidation, but also increase the elastic factor of the metal foil 200 so that a resilient flange fabricated in the subsequent processes can have enough elasticity. On the other hand, the gold parts 210 are used to prevent oxidation and reactions of the gold-plated regions. As shown in FIG. 2C, a patterned metal foil 200b is formed through patterning, shaping processes and so forth. The patterned metal foil 200b includes an array of resilient flange patterns 202 and each resilient flange pattern 202 includes a fixed end 230, a curved extending portion 240 and a free distal end 250, wherein the free distal end 250 is composed of nickel and gold parts 210 or the combination thereof. It should be noted that, the above-mentioned sequences for fabricating the patterned metal foil 200b are not the only choices. Depending on different requirements, the patterning and shaping processes may be carried out first before performing the plating processes of nickel and gold.

Please refer to FIGS. 2D to 2E, wherein FIG. 2D is a schematic diagram showing a connector after imposing the metal foil 220b shown in FIG. 2C to an anisotropic conductive adhesive 150 and the substrate 100 simultaneously followed by performing a circuit patterning process, and FIG. 2E is a schematic, three-dimensional diagram of the connector shown in FIG. 2D. As shown in FIG. 2D, the metal foil 220b, an anisotropic conductive adhesive 150 and the substrate 100 are combined together simultaneously. Then a circuit patterning process is performed to form several resilient flanges 201 by etching away a portion of the metal foil 220b. The resilient flanges 201 are metal flanges including a fixed end 230, a curved extending portion 240 and a free distal end 250. At this time, a connector 500 is formed. In this embodiment, since openings 150a corresponding to the positions of the plated through vias 110 are formed before combining the anisotropic conductive adhesive 150 with the substrate 100, the anisotropic conductive adhesive 150 can cover the pads 140 but does not cover or plug the plated through vias 110. It should be noted that the composition of the anisotropic conductive adhesive 150 includes conductive particles and polymers. The anisotropic conductive adhesive 150 can not only serve to adhere and fix the metal foil 200 to the substrate 100 but also has a character of conducting electricity (or an electrical signal) along a single orientation. In this embodiment, the conductivity of the anisotropic conductive adhesive 150 along a direction Z perpendicular to the surface 101 of the substrate 100 is much higher than that in a plane XY parallel to the surface 101. In other words, the anisotropic conductive adhesive 150 may be deemed as an insulator in the plane XY. Additionally, the size of the conductive particles and the material of the polymer of the anisotropic conductive adhesive may be changed in order to meet various conductivity requirements. As shown in FIG. 2E, the resilient flange 201 is physically connected to the anisotropic conductive adhesive 150 only through the fixed end 230. Furthermore, the resilient flange 201 is electrically connected the pads 140 through the anisotropic conductive adhesive 150. Since the processes for plating the nickel or gold parts 210 is accomplished before combining the resilient flanges 201 with the substrate 100, overall fabricating processes are therefore simplified, compared to conventional fabrication methods. During subsequent assembly processes, a chip module may be electrically connected to inner circuits inside the PCB through the resilient flanges 201 located in the connector 500.

Please refer to FIG. 2F, which is a schematic, partially enlarged diagram of the connector encircled in FIG. 2D. As shown in FIG. 2F, the anisotropic conductive adhesive 150 is interposed between the pads 140 and the fixed end 230 of the resilient flange 230. Once a chip module (not shown) is assembled with the connector 500 and is physically in contact with the free distal end 250, the anisotropic conductive adhesive 150 will therefore sustain a force along a vertical direction Z from the resilient flanges 201. As a result, the distance between an upper surface 153 and lower surface 255 of the anisotropic conductive adhesive 150 shrinks, so that the conductance of the anisotropic conductive adhesive 150 along the vertical direction Z is increased (a conductive region and its direction are indicated by double arrows 152). It should be noted that, in contrast, since no force is applied to the plane XY, the anisotropic conductive adhesive 150 may be deemed as an insulator in the plane XY. Additionally, because the resilient flange 201 is electrically in contact with the pad 140 only through the anisotropic conductive adhesive 150, there is no plated conductive layer (electroplated or electroless plated) on the sidewall 151 of the anisotropic conductive adhesive 150.

FIG. 3 is schematic diagram showing a connector according to one embodiment of the invention. The main difference between the structures shown in FIGS. 3 and 2D is that the conductive via in the core dielectric 720 is plugged with a conductive paste 710, like copper, aluminum or other metal or an alloy with relatively low resistivity. The conductive paste 710 filling up each conductive via may penetrate through the sides of the core dielectric 720 and electrically connect the pads 140 to 142. Similarly to FIG. 2D, the resilient flange 201 shown in FIG. 3 is a metal flange which includes a fixed end 230, a curved extending portion 240 and a free distal end 250, wherein the free distal end 250 includes a nickel or gold part 210 or a combination thereof. Similarly, the anisotropic conductive adhesive 150 can not only serve to adhere and fix the resilient flange 201 to the substrate 720 but also has to conduct electricity (or an electrical signal) along a single orientation. In this embodiment, the conductivity of the anisotropic conductive adhesive 150 along a direction Z is relatively high. In other words, the anisotropic conductive adhesive 150 may be deemed as an insulator in the plane XY. As shown in FIG. 2E, the resilient flange 201 is physically contacted with the anisotropic conductive adhesive 150 only through the fixed end 230. Furthermore, the resilient flange 201 is electrically in contact with the pads 140 through the anisotropic conductive adhesive 150.

Additionally, in all embodiments of the invention, another anisotropic conductive adhesive 150 and patterned metal foil 200b may optionally be combined to the second surface 102. A portion of the patterned metal foil 200b is then removed to keep only the fixed end 230 and the free distal end 250, that is to say that a quadric-layered connector (not shown) is obtained.

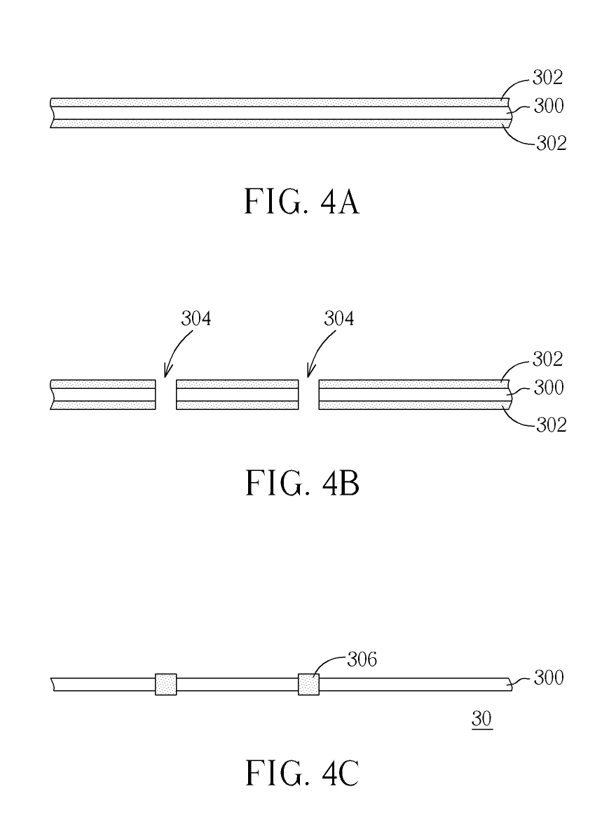

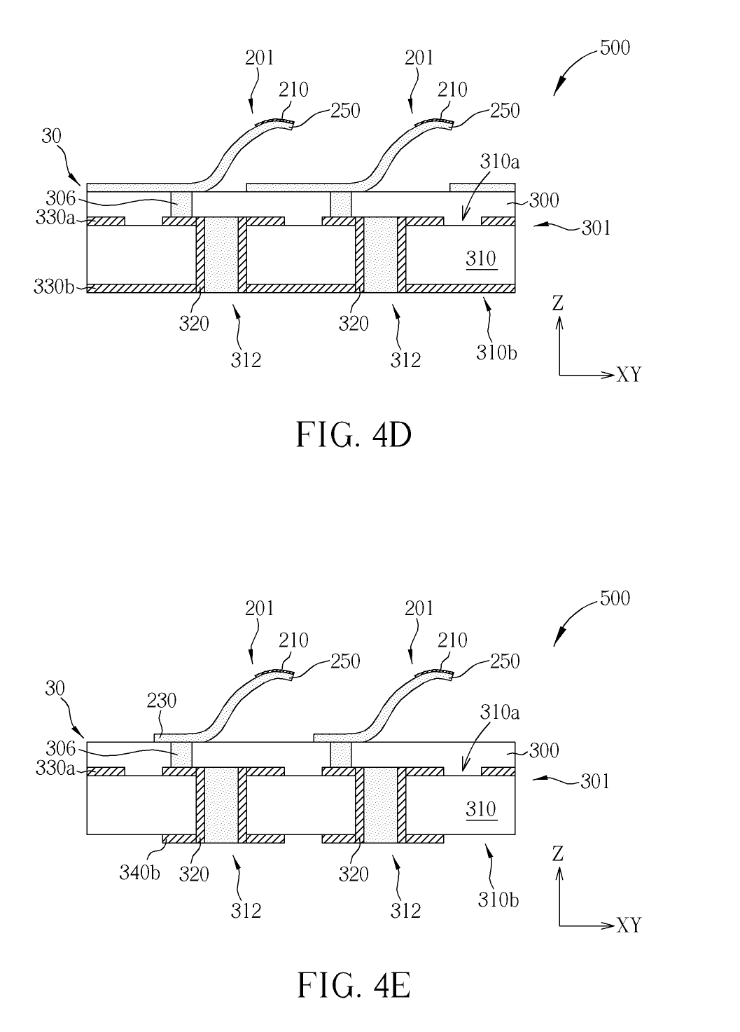

The first exemplary embodiment is described in the preceding paragraph. In that case, the resilient flange 201 is physically connected to the anisotropic conductive adhesive 150 only through the fixed end 230. Furthermore, the resilient flange 201 is electrically in contact with the pads 140 through the anisotropic conductive adhesive 150. In the second exemplary embodiment of the invention, however, an adhesive layer 30 is used to replace the anisotropic conductive adhesive 150 and the related fabricated method is described as follows. FIGS. 4A to 4C are schematic, cross-sectional diagrams showing a method for fabricating an adhesive layer used in a connector according to one embodiment of the invention. As shown in FIG. 4A, an adhesive material 300, such as a low-flow prepreg, is provided, and each of its surfaces may be covered by at least a layer of protective layer 302, like polyethylene terephthalate (PET) film, but is not limited thereto. Then, as shown in FIG. 4B, several holes 304 are formed through the protective layer 302 and the adhesive material 300 by laser or mechanical drilling processes, but is not limited thereto. After the preceding steps, as shown in FIG. 4C, a conductive paste 306 is applied to fill up each hole 304. The conductive paste 306 includes copper paste, tin paste or other materials with suitable conductivity. Finally, the protective layers 302 are removed so that the conductive pastes 306 can protrude from the surface of the adhesive material 300. At this time, an adhesive layer 30 used in the connector of the present invention is obtained.

FIGS. 4D to 4E are schematic diagrams showing a method for fabricating connectors according to the second exemplary embodiment of the present invention. Similarly to the first exemplary embodiment, the adhesive layer 30 and the patterned metal foil 200b are then combined with the substrate 301, and the steps for fabricating the substrate 301 are disclosed as follows. First, a core dielectric is provided, wherein a first surface 310a and a second surface 310b are disposed oppositely to the first surface. The first conductive layer (not shown) and the second conductive layer 330b are located on the first surface 310a and the second surface 310b respectively. Then, a plurality of through vias (not shown) is formed in the core dielectric 310, plating processes and plugging processes are performed afterwards, in order to have the through vias plugged in conductive materials (not shown), such as conductive pastes. As a result, several conductive vias having conductive materials are obtained. Finally, a first circuit layer 330a is formed on the first surface 310a through patterning processes. Through the above steps, the substrate 301 in accordance with this exemplary embodiment is accomplished, wherein the first circuit layer 330a is electrically in contact with the second conductive layer 330b through the conductive vias 312. As shown in FIG. 4D, the adhesive layer 30 and the patterned metal foil 200b are then combined with the substrate 301 to have the adhesive layer 30 interposed between the substrate 301 and the patterned metal foil 200b. The fixed end 230 of the resilient flange 201 is electrically connected to the first circuit layer 330a through the anisotropic conductive adhesive 150

Please refer to FIG. 4E. In FIG. 4E an etching process is performed to form several resilient flanges 201 by etching away a portion of the metal foil 220b. At the same time, the second conducive layer 330b is patterned to form a second circuit layer 340b. Thus, a connector 500 is formed. Similarly, the resilient flange 201 is a metal flange which includes a fixed end 230, a curved extending portion 240 and a free distal end 250.

Additionally, similarly to the first exemplary embodiment, another adhesive layer 30 and a patterned metal foil 200b may optionally be combined with the second surface 310b. A portion of the patterned metal foil 200b is then removed to keep only the fixed end 230 and the free distal end 250, that is to say that a quadric-layered connector (not shown) is obtained.

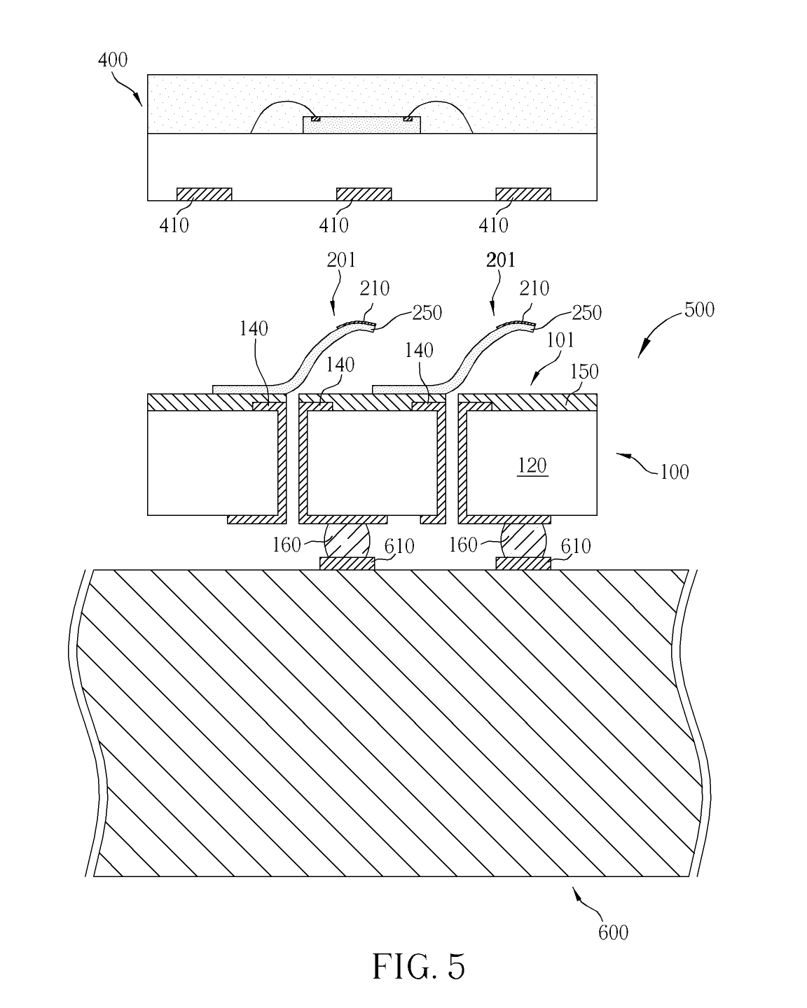

FIG. 5 is a schematic, cross-sectional diagram showing an interposer interposed between a chip module and a PCB according to one embodiment of the invention. The connector 500 is interposed between the chip module 400 and the PCB 600, wherein the position of the pads 410 in the chip module 400 is corresponding to that of the free distal ends 250 in the connector 500. Similarly, the positions of solder bumps 160 correspond to those of pads 610 on the surface of the PCB. This way, the chip module 400 is connected to the PCB 600 through the connector 500.

In summary, the present invention provides the connector 500. The resilient flange 201 is electrically in contact with the pads 140 through the anisotropic conductive adhesive 150 (or adhesive layer 30). In the fabricating processes provided in the invention, electroplating or electroless plating processes used to electrically connect the resilient flange 201 with the pads 140 can be omitted. In addition, since each free distal end 250 is plated with nickel, gold or the combination thereof before combining the anisotropic conductive adhesive 150 (or adhesive layer 30) with the resilient flange 201, plating processes after the combination processes are omitted. Therefore, the complexity and cost of the processes can be reduced. Drawbacks such as the conductive metal layer near the plated through via and the resilient flange 20 that is prone to break in the prior art can be overcome.

Although the disclosure has been illustrated by references to specific embodiments, it will be apparent that the disclosure is not limited thereto as various changes and modifications may be made thereto without departing from the scope of the present invention. References to “one embodiment’ or “an embodiment’ mean that a particular feature, structure or characteristic described therein is included in at least one embodiment. Thus, the appearances of the phrase “in one embodiment” or ‘in an embodiment” appearing in various places throughout the specification are not necessarily all referring to the same embodiment. The various embodiments intend to be protected broadly within the spirit and scope of the appended claims.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A connector, comprising:
a substrate;
at least a conductive via disposed inside the substrate;
a pad disposed on one surface of the substrate and electrically connected to the conductive via;
a resilient flange disposed on the pad; and
an anisotropic conductive adhesive interposed between the pad and the resilient flange to electrically connect the pad to the resilient flange.

2. The connector according to claim 1, wherein the resilient flange is a metal cantilever.

3. The connector according to claim 1, wherein the anisotropic conductive adhesive only has a conductance along a direction perpendicular to the surface of the substrate.

4. The connector according to claim 1, wherein the pad is electrically in contact with the resilient flange only through the anisotropic conductive adhesive.

5. The connector according to claim 1, wherein the conductive hole is not covered by the anisotropic conductive adhesive.

6. A method for fabricating a connector, comprising:
providing a substrate having at least a conductive via;
forming at least a pad on a surface of the substrate, wherein the pad is electrically in contact with the conductive via; and
imposing an anisotropic conductive adhesive and a resilient flange on the surface of the substrate so that the resilient flange is electrically in contact with the pad through the anisotropic conductive adhesive.

7. The method for fabricating the connector according to claim 6, wherein the anisotropic conductive adhesive has a conductance only along a direction perpendicular to the surface of the substrate.

8. The method for fabricating the connector according to claim 6, wherein the conductive via is not covered by the anisotropic conductive adhesive.

9. The method for fabricating the connector according to claim 6, wherein the resilient flange comprises a fixed end, a curved extending portion and a free distal end.

10. The method for fabricating the connector according to claim 9, further comprising:
plating nickel, gold or the combination thereof on the free distal end before imposing the resilient flange on the anisotropic conductive adhesive.

11. A connector, comprising:
a substrate comprising a core dielectric, a first circuit layer, a second circuit layer and at least one conductive via, wherein the dielectric core has a first surface and a second surface opposite to the first surface, the first circuit layer and the second circuit layer are located on the first surface and the second surface respectively, and the conductive via is located in the core dielectric and connected to the first circuit layer and the second circuit layer;
at least a resilient flange disposed on the first circuit layer, wherein the resilient flange comprises a fixed end and a free distal end connected to the fixed end, and an upper surface of the free distal end is higher than an upper surface of the fixed end; and
an adhesive layer interposed between the first circuit layer and the resilient flange, wherein the adhesive layer has at least one through hole plugged with a conductive material and the conductive material is electrically in contact with the first circuit layer and the fixed end.

12. The connector according to claim 11, further comprising a nickel layer positioned on a portion of the resilient flange.

13. The connector according to claim 12, further comprising a gold layer positioned on a portion of the free distal end.

14. A method for fabricating a connector, comprising:
providing a substrate comprising a core dielectric, a first circuit layer, a conductive layer and at least one conductive via, wherein the core dielectric has a first surface and a second surface opposite to the first surface, the first circuit layer and the conductive layer are located on the first surface and the second surface respectively, and the conductive via is located in the core dielectric and connected to the first circuit and the conductive layer;
providing an adhesive layer having at least one through hole plugged with a conductive material;
providing a patterned metal foil having at least a resilient flange pattern, wherein the resilient flange comprises a fixed end and a free distal end connected with the fixed end;
imposing the adhesive layer and the patterned metal foil on the substrate, wherein the adhesive material is interposed between the substrate and the patterned metal foil, and the conduct material is electrically in contact with the first circuit layer and the fixed end;
removing a portion of the patterned metal foil to keep the fixed end and the free distal end, wherein the fixed end and the free distal end consist of a resilient flange; and
patterning the conductive layer to form a second circuit layer.

15. The method for fabricating the connector according to claim 14, wherein a method of forming the substrate comprises:
forming a first conductive layer and a second conductive layer on the first surface and the second surface respectively;
forming at least a through via penetrating the first conductive layer, the core dielectric and the second conductive layer;
forming a third conductive layer on sidewalls of the through via;
plugging the through via with a conductive material; and
patterning the first conductive layer to form the first circuit layer.

16. The method for fabricating the connector according to claim 14, wherein a method for forming the adhesive layer comprises:
providing an adhesive material having at least a protective layer on each surface of the adhesive material;
forming the through hole penetrating the adhesive material and the protective layer;
plugging the through hole with the conductive material; and
removing the protective layer.

17. The method for fabricating the connector according to claim 14, wherein a method for forming the patterned metal foil comprises:
providing a metal foil;
performing an etching process to remove a portion of the metal foil so that the resilient flange is formed; and
performing a punch process to have an upper surface of the free distal end higher than an upper surface of the fixed end.

18. The method for fabricating the connector according to claim 17, further comprising:
forming a nickel layer positioned on a portion of the resilient flange after performing the punch process.

19. The method for fabricating the connector according to claim 18, further comprising:
forming a gold layer positioned on a portion of the free distal end after forming the nickel layer.
